(19) United States
(12) Patent Application Publication
(10) Pub. No.: US 2008/0239263 A1
(43) Pub. Date: Oct. 2, 2008

(54) Lithographic system and device manufacturing method

(75) Inventor: Anton Josef Gerard De Vries, Veldhoven (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 11/730,188

(22) Filed: Mar. 29, 2007

(51) Int. Cl. G03B 27/42; G03C 5/00

(52) U.S. Cl. 355/53; 355/77; 430/269

(57) ABSTRACT

A lithographic system is arranged to project a pattern from a patterning device onto a substrate. The patterning device includes a first pattern on a first region of the patterning device and a second pattern on a second region of the patterning device. A filter arrangement selectively reduces transmission through the second region of the patterning device of radiation, so as to reduce the intensity of one or more images of the second pattern caused by a portion of the radiation beam which is indirectly incident on the second region of the patterning device.

### FIELD

The present invention relates to a lithographic system and a method for manufacturing a device.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. including part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at once, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

The reticle may include a test pattern which is printed only once on every wafer. The inventor has observed ghost images appearing on the substrate on regions of the substrate which should not have an image of the test pattern. Such ghost images create a particular problem as they may affect the critical dimensions (CDs) of an actual die which it is required to produce on the substrate, if the ghost image overlaps with the die on the substrate.

### SUMMARY

It is desirable to provide a lithographic system and method in which the production of such ghost images on the wafer are at least reduced.

According to an embodiment of the invention, there is provided a lithographic system including a lithographic apparatus arranged to project a pattern from a patterning device onto a substrate and a patterning arrangement, the lithographic apparatus including an illumination system configured to condition a radiation beam; the patterning arrangement including a patterning device being capable of imparting the radiation beam with a pattern in its cross-section to form a patterned radiation beam, the patterning device including a first pattern on a first region of the patterning device and a second pattern on a second region of the patterning device; the lithographic apparatus further comprising: a projection system configured to project the patterned radiation beam onto a target portion of the substrate; the patterning arrangement further including a filter arrangement configured to selectively reduce transmission through the second region of the patterning device of radiation so as to reduce the intensity of one or more images of the second pattern caused by a portion of the radiation beam which is indirectly incident on the second region of the patterning device.

According to a further embodiment of the invention, there is provided a patterning arrangement including a patterning device for use in a lithographic system for projecting a pattern from the patterning device onto a substrate, the patterning device being capable of imparting a radiation beam incident on the patterning device with a pattern in its cross-section to form a patterned radiation beam, the patterning device including a first pattern on a first region of the patterning device and a second pattern on a second region of the patterning device; the patterning arrangement further including: a filter arrangement configured to selectively reduce transmission through the second region of the patterning device of radiation so as to reduce the intensity of one or more images of the second pattern caused by a portion of the radiation beam which is indirectly incident on the second region of the patterning device.

According to a yet further embodiment of the invention, there is provided a device manufacturing method including projecting a patterned beam of radiation onto a substrate, wherein the method includes directing a radiation beam onto a patterning device, the patterning device being capable of imparting the radiation beam with a pattern in its cross-section to form a patterned radiation beam, the patterning device including a first pattern on a first region of the patterning device and a second pattern on a second region of the patterning device; projecting the patterned radiation beam onto a target portion of the substrate; selectively reducing transmission through the second region of the patterning device of radiation so as to reduce the intensity of one or more images of the second pattern caused by a portion of the radiation beam which is indirectly incident on the second region of the patterning device.

According to an embodiment of the invention, there is provided a lithographic apparatus including an illumination system configured to condition a beam of radiation; a pattern support configured to support a patterning arrangement, the patterning arrangement including a patterning device capable of imparting the radiation beam with a pattern in its cross-section to form a patterned radiation beam, the patterning device including a first pattern on a first region of the patterning device and a second pattern on a second region of the patterning device; and a filter arrangement configured to selectively reduce transmission of radiation through the second region of the patterning device so as to reduce the intensity of one or more images of the second pattern caused by a portion of the radiation beam which is indirectly incident on the second region of the patterning device, a substrate table configured to hold a substrate; and a projection system configured to project the patterned radiation beam onto a target portion of the substrate.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic system, including a lithographic apparatus and a patterning arrangement;

FIG. 2 illustrates schematically the production of a ghost image on a wafer in the system of FIG. 1; and

FIG. 3 is a schematic plan view of a patterning arrangement incorporated in a lithographic system in accordance with an embodiment of the invention; and

FIG. 4 illustrates a lithographic system in accordance with an embodiment of the invention including the patterning arrangement of FIG. 3.

### DETAILED DESCRIPTION

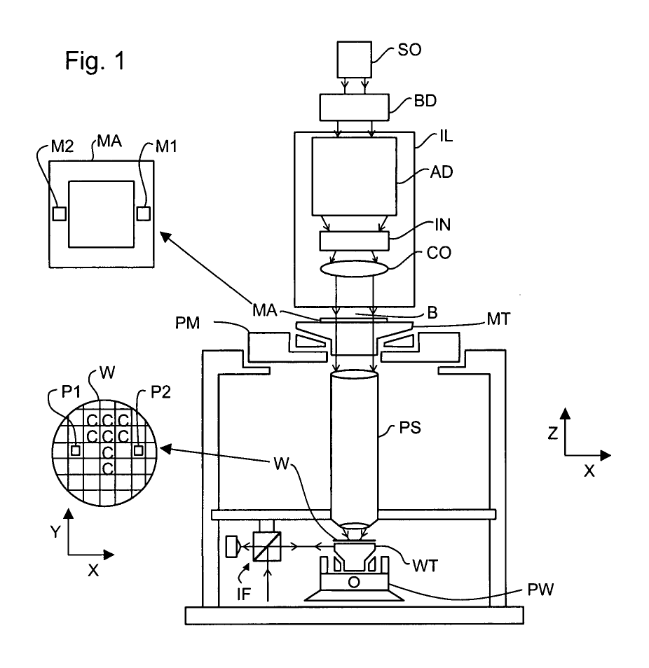

FIG. 1 schematically depicts a lithographic system including a lithographic apparatus and a patterning arrangement according to one embodiment of the invention. The apparatus includes an illumination system (illuminator) IL configured to condition a radiation beam B (e.g. UV radiation); a support structure (e.g. a mask table) MT constructed to support a patterning device (e.g. a mask) MA and connected to a first positioner PM configured to accurately position the patterning device in accordance with certain parameters; a substrate support or substrate table (e.g. a wafer table) WT constructed to hold a substrate (e.g. a resist-coated wafer) W and connected to a second positioner PW configured to accurately position the substrate in accordance with certain parameters; and a projection system (e.g. a refractive projection lens system) PS configured to project a pattern imparted to the radiation beam B by patterning device MA onto a target portion C (e.g. including one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure supports, i.e. bears the weight of, the patterning device. It holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD including, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may include an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may include various other components, such as an integrator IN and a condenser CO. The illuminator may be used to condition the radiation beam, to have a desired uniformity and intensity distribution in its cross-section.

The radiation beam B is incident on the patterning device (e.g., mask MA), which is held on the support structure (e.g., mask table MT), and is patterned by the patterning device. Having traversed the patterning device (e.g., mask) MA, the radiation beam B passes through the projection system PS, which focuses the beam onto a target portion C of the substrate W. With the aid of the second positioner PW and position sensor IF (e.g. an interferometric device, linear encoder or capacitive sensor), the substrate table WT can be moved accurately, e.g. so as to position different target portions C in the path of the radiation beam B. Similarly, the first positioner PM and another position sensor (which is not explicitly depicted in FIG. 1) can be used to accurately position the patterning device (e.g. mask) MA with respect to the path of the radiation beam B, e.g. after mechanical retrieval from a mask library, or during a scan. In general, movement of the support structure (e.g. mask table) MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only, or may be fixed. Patterning device (e.g. mask) MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the patterning device (e.g. mask) MA, the mask alignment marks may be located between the dies.

The depicted apparatus could be used in at least one of the following modes:

1. In step mode, the support structure (e.g. mask table) MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the support structure (e.g. mask table) MT and the substrate table WT are scanned synchronously while a pattern imparted to the radiation beam is projected onto a target portion C (i.e. a single dynamic exposure). The velocity and direction of the substrate table WT relative to the support structure (e.g. mask table) MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the support structure (e.g. mask table) MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

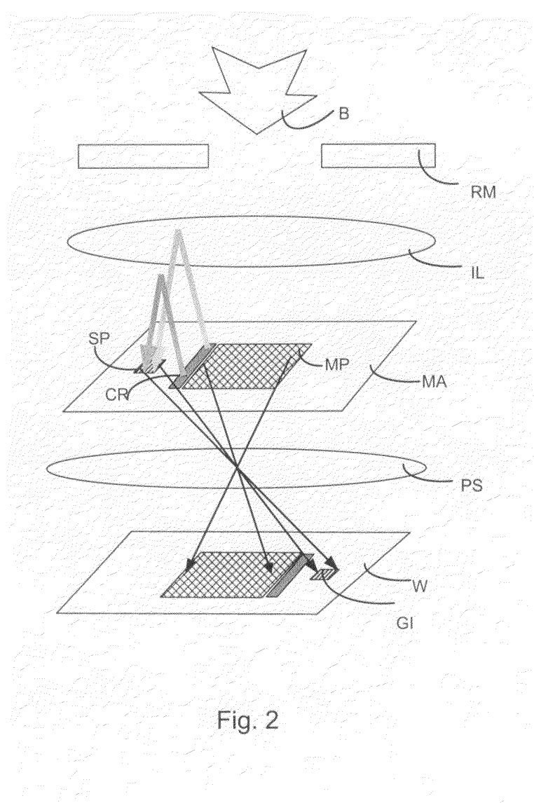

Turning now also to FIG. 2, the patterning device (e.g. mask) MA will often include a number of separate patterns on different regions of the mask effective to be projected simultaneously onto different regions of the substrate W. These patterns may include a main pattern MP which may be repeated several times over the patterning device (e.g. mask) MA. For the sake of clarity the main pattern MP is only shown once in the Figures. The patterning device (e.g. mask) may also include a supplementary pattern SP which may correspond to another die or to a test pattern for use in calibrating the apparatus. Typically the main pattern MP will be surrounded by a chromium border CR, only part of which is shown in the Figures.

The inventor has observed that the supplementary pattern SP in the patterning device (e.g. mask) MA may produce a ghost image GI in the image projected on the wafer W. The inventor has particularly noted that such ghost images may occur, even when a reticle mask RM is interposed between the illuminator IL and the patterning device (e.g. mask) MA, the reticle mask RM having a square or rectangular aperture so as to restrict the area of the beam B incident on the patterning device (e.g. mask) MA, such that the supplementary pattern SP does not lie in the direct beam path through the patterning device (e.g. mask) MA. The inventor has performed a number of experiments, varying the size of the aperture in the reticle mask RM and varying the position of the aperture with respect to the position of the supplementary pattern SP on the mask MA. From these experiments, the inventor has deduced that the ghost images on the wafer W, are produced from stray light which has been reflected from the patterning device (e.g. mask) MA in particular the chromium border CR, onto various surfaces of the optical components of the illumination system IL, examples of this stray light being depicted by the gray arrows in FIG. 2. It will be appreciated that while the illumination system IL has been depicted as a single lens in FIG. 2, in reality the illumination system IL as mentioned above in relation to FIG. 1, includes a large number of optical surfaces on any one of which these reflections may occur. The light reflected by the optical surfaces onto the supplementary pattern SP in the mask MA is then imaged by the projection system PS to form the ghost images GI on the wafer W.

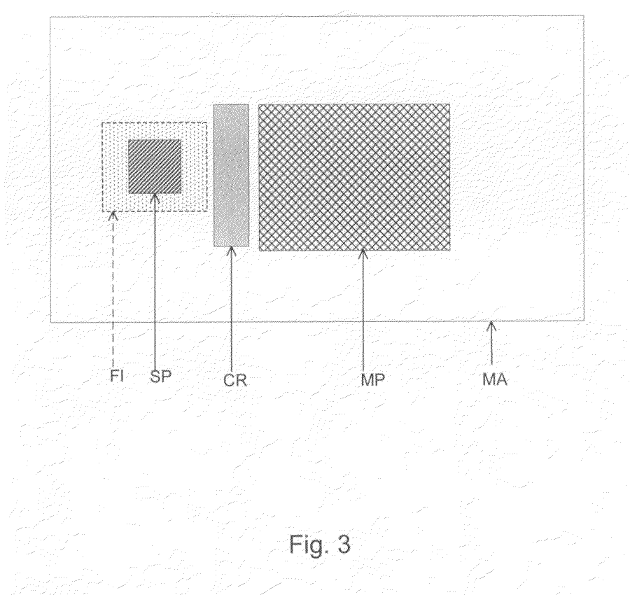

Referring now also to FIG. 3, in order to overcome the problem of ghost images which has been identified by the inventor, in accordance with an embodiment of the invention, a filter FI is inserted under the region of the patterning device (e.g. mask) MA including the supplementary pattern SP. The filter arrangement may be attached to the support structure and/or at the surface of the patterning device remote from the illumination system. The filter FI is arranged to have a transmission of x %, typically 5% although any value of x can be chosen. The filter causes the ghost image of the supplementary pattern SP projected on the wafer W to be suppressed by 100−x %, that is 95% in this particular example.

The filter FI is preferably a homogeneous gray filter. A pattern of dots, as indicated in FIG. 3 may be used to produce the homogeneous gray filter. In this case the size of the dots must be smaller than the resolution of the lithography system.

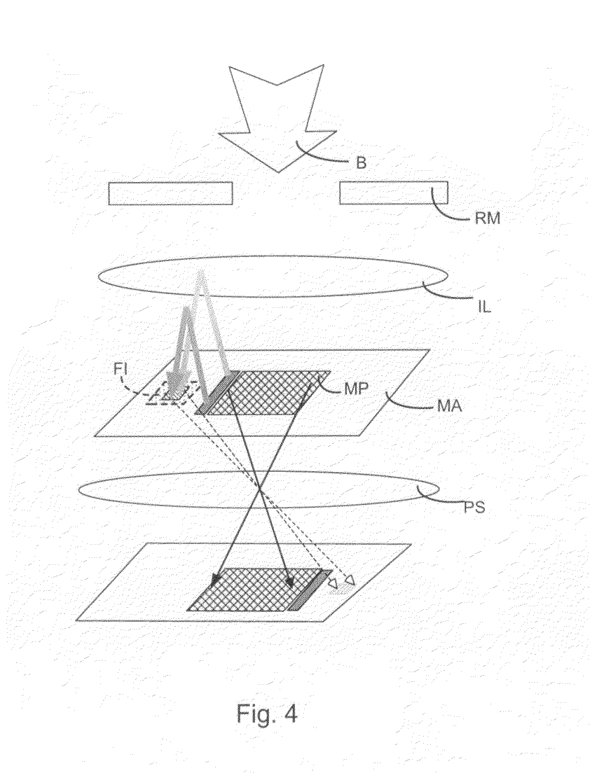

The effect of the filter FI can be seen in FIG. 4. As can be seen from this Figure the effect of the ghost image GI projected on the wafer W is reduced by the presence of the filter FI. In some cases it is found that the ghost image GI is virtually removed.

It will be appreciated that where the supplementary pattern SP is a test pattern which is not required to be printed on every wafer, the reticle mask RM may be used to reduce the size of the beam B incident on the patterning device (e.g. mask) MA such that the supplementary pattern is not directly irradiated and the inclusion of the filter FI will not affect the processing time. Where it is required to print the supplementary pattern SP on the patterning device (e.g. mask) MA, it may be desirable to increase the exposure time in order to enable the supplementary pattern SP to be imaged on the wafer W. However, the relative prominence of the ghost image GI on the wafer W will still be reduced.

It will be appreciated that by use of a lithographic system in accordance with the invention, it is possible for a user of the lithographic system to correct for variations in critical dimensions of a die caused by ghost images, without any further calculations being necessary.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 355, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

1. A lithographic system comprising:
a patterning arrangement including
a patterning device capable of imparting a radiation beam with a pattern in its cross-section to form a patterned radiation beam, the patterning device including a first pattern on a first region of the patterning device and a second pattern on a second region of the patterning device; and
a filter arrangement configured to selectively reduce transmission of radiation through the second region of the patterning device so as to reduce the intensity of one or more images of the second pattern caused by a portion of the radiation beam which is indirectly incident on the second region of the patterning device, and
a lithographic apparatus including
an illumination system configured to condition the radiation beam; and
a projection system configured to project the patterned radiation beam onto a target portion of a substrate.

2. A system according to claim 1, wherein the lithographic apparatus includes an aperture setting arrangement effective to restrict the cross-sectional area of the radiation beam incident on the patterning device such that the radiation beam is not directly incident on the second region.

3. A system according to claim 2, wherein the second pattern is a test pattern.

4. A system according to claim 1, wherein the first pattern is repeated on further regions of the patterning device.

5. A system according to claim 1, wherein the filter arrangement comprises a homogeneous gray filter.

6. A system according to claim 5, wherein the filter comprises a series of dots.

7. A system according to claim 1, wherein the filter arrangement is attached to a support structure configured to support the patterning device at a surface of the patterning device remote from the illumination system.

8. A patterning arrangement comprising:
a patterning device for use in a lithographic system and configured to project a pattern from the patterning device onto a substrate, the patterning device being capable of imparting a radiation beam incident on the patterning device with a pattern in its cross-section to form a patterned radiation beam, the patterning device including a first pattern on a first region of the patterning device and a second pattern on a second region of the patterning device; and
a filter arrangement configured to selectively reduce transmission through the second region of the patterning device of radiation so as to reduce the intensity of one or more images of the second pattern caused by a portion of the radiation beam which is indirectly incident on the second region of the patterning device.

9. A patterning arrangement according to claim 8, wherein the second pattern is a test pattern.

10. A patterning arrangement according to claim 8, wherein the first pattern is repeated on further regions of the patterning device.

11. A patterning arrangement according to claim 8, wherein the filter arrangement comprises a homogeneous gray filter.

12. A patterning arrangement according to claim 11, wherein the filter comprises a series of dots.

13. A patterning arrangement according to claim 8, wherein the filter arrangement is attached to a support structure configured to support the patterning device at a surface of the patterning device remote from the illumination system.

14. A device manufacturing method comprising:
directing a radiation beam onto a patterning device, the patterning device being capable of imparting the radiation beam with a pattern in its cross-section to form a patterned radiation beam, the patterning device including a first pattern on a first region of the patterning device and a second pattern on a second region of the patterning device;
selectively reducing transmission through the second region of the patterning device of radiation so as to reduce the intensity of one or more images of the second pattern caused by a portion of the radiation beam which is indirectly incident on the second region of the patterning device; and
projecting the patterned beam of radiation onto a target portion of a substrate.

15. A method according to claim 14, restricting the cross-sectional area of the radiation beam incident on the patterning device such that the radiation beam is not directly incident on the second region.

16. A method according to claim 15, wherein the second pattern is a test pattern.

17. A method according to claim 15, wherein the first pattern is repeated on further regions of the patterning device.

18. A method according to claim 14, wherein the selectively reducing is performed with a homogeneous gray filter.

19. A method according to claim 18, wherein the filter comprises a series of dots.

20. A method according to claim 14, wherein the selectively reducing is performed with a filter arrangement attached to a surface of the patterning device remote from an illumination system, the illumination system configured to condition the radiation beam.

21. A lithographic apparatus comprising:
an illumination system configured to condition a beam of radiation;
a pattern support configured to support a patterning arrangement, the patterning arrangement including
a patterning device capable of imparting the radiation beam with a pattern in its cross-section to form a patterned radiation beam, the patterning device including a first pattern on a first region of the patterning device and a second pattern on a second region of the patterning device; and
a filter arrangement configured to selectively reduce transmission of radiation through the second region of the patterning device so as to reduce the intensity of one or more images of the second pattern caused by a portion of the radiation beam which is indirectly incident on the second region of the patterning device;
a substrate table configured to hold a substrate; and
a projection system configured to project the patterned radiation beam onto a target portion of the substrate.
